(19) United States
(12) Patent Application Publication
(10) Pub. No.: US 2015/0160871 A1
(43) Pub. Date: Jun. 11, 2015

(54) STORAGE CONTROL DEVICE AND METHOD FOR CONTROLLING STORAGE DEVICE

(71) Applicant: FUJITSU LIMITED, Kawasaki-shi (JP)

(72) Inventor: Atsushi Takakura, Kawasaki (JP)

(73) Assignee: Fujitsu Limited, Kawasaki (JP)

(21) Appl. No.: 14/532,164

(22) Filed: Nov. 4, 2014

(30) Foreign Application Priority Data
Dec. 11, 2013 (JP) 2013-255859

(51) Int. Cl. G06F 3/06

(52) U.S. Cl. CPC G06F 3/0619; G06F 3/0689; G06F 3/0665

(57) ABSTRACT

A storage control device includes controllers and storage units. The controllers are associated with first storage regions. The controllers are configured to control access to first storage regions associated with the respective controllers. The storage units are provided for the respective controllers. Each of the storage units has a second storage region to which unit storage regions secured in the plurality of first storage regions are assigned. Each of the unit storage regions is associated with any one of the controllers. Each of the controllers includes a processor configured to assign a new unit storage region to the second storage region. The processor is configured to change, upon the assignment of the new unit storage region, arrangement of the unit storage regions assigned to the second storage region so that unit storage regions associated with a same controller are continuously arranged in the second storage region.

### CROSS-REFERENCE TO RELATED APPLICATION

This application is based upon and claims the benefit of priority of the prior Japanese Patent Application No. 2013-255859, filed on Dec. 11, 2013, the entire contents of which are incorporated herein by reference.

### FIELD

The embodiments discussed herein are related to a storage control device and a method for controlling a storage device.

### BACKGROUND

A large amount of data handled by a computer (hereinafter referred to as server) such as a business server is managed using a storage device such as a redundant arrays of inexpensive disks (RAID) device, which includes a plurality of hard disk drives (HDDs) and possesses higher reliability. Recently, a storage system in which a server is connected to a plurality of storage devices through a network called a storage area network (SAN) has been widely used.

A storage region (hereinafter referred to as physical region) of the storage device is divided into units (logical units (LUs)) of logical storage regions and recognized by the server on an LU basis. For example, identification information called a logical unit number (LUN) is assigned to each LU, and the server references an LUN and thereby recognizes an LU. An LU set within a RAID group is referred to as a RAID LU (RLU) in some cases.

In recent years, virtualization of storage has attracted attention. The virtualization of storage is a technique in which a virtualization engine is installed between a storage device and a server and the server utilizes the virtualization engine as a single virtual storage device. The virtualization engine prepares a virtual LU different from an LU (hereinafter referred to as a physical LU) obtained by dividing the physical region and assigns, to the virtual LU, a storage region selected from among one or more physical LUs.

A relationship between storage regions recognized by a server and physical region is highly abstracted with the virtual LU, and improvement in the usage efficiency and the flexibility of an operation may be expected. If the virtualization of storage is employed, the server accesses the virtual LU in order to read and write data. That is, the server achieves access to the physical LUs through the virtualization engine. For the storage system having the aforementioned mechanism, a method for building a multi-path environment, in which access paths from the server to the physical LUs are set redundantly in order to improve the reliability, has been proposed.

In the multi-path environment, even if a part of the access paths fails, an operation may continue using a normal access path. This contributes to the improvement of the reliability of the storage system. The selection of an access path within the multi-path environment may be achieved using a report target port groups (RTPG) command, for example. The RTPG command is one of small computer system interface (SCSI) commands. When the server issues the RTPG command, the storage device that receives the RTPG command notifies the server of a recommended access path (hereinafter referred to as recommended path). Then, the server uses the notified recommended path to read and write data.

There is a technique called thin provisioning that is one of techniques for increasing the utilization of a physical region of a virtualized storage system. Normally, a physical region with a size requested by the server is assigned to a virtual LU. In the storage system to which thin provisioning is applied, a physical region with the requested size or less is assigned depending on a capacity to be used while a virtual LU (hereinafter referred to as thin provisioning volume (TPV)) with the requested size is set. Thus, the storage system may operate with a storage capacity suitable for an actual operation, and improvement in the utilization and reduction of cost for the start of the operation may be expected.

For a virtualized storage system, a method for appropriately controlling an assignment of a physical region to a virtual LU has been proposed in order to avoid fragmentation and improve the usage efficiency of the physical region. In addition, for the assignment of a physical region to a TPV, a method for identifying an unassigned physical region on the basis of management information, dividing the identified unassigned physical region into a plurality of sub-regions, and assigning the sub-regions to continuous regions regularly arranged in the TPV has been proposed.

Related techniques are disclosed in, for example, Japanese Laid-open Patent Publication No. 2007-157089, Japanese Laid-open Patent Publication No. 2004-164370, and Japanese Laid-open Patent Publication No. 2008-59353.

As described above, the selection of the access path within the multi-path environment is achieved by causing the storage device to notify the server of the recommended path. If a single recommended path is identified for each physical LU, the recommended path may be notified using the RTPG command as described above. If it is not a case where a single recommended path is identified for each physical LU, for example, if the TPV is used, the server may receive a notification representing a recommended path for each of logical block addressing (LBA) ranges of a virtual LU by using a report referrals (RR) command. The RR command is one of the SCSI commands.

If recommended paths are managed for respective LBA ranges, the number of recommended paths to be managed for each physical LU may be two or more, and the data size of the management information may be larger, compared with a case where recommended paths are managed for respective physical LUs. The data size of the management information is increased on the basis of the number of divided LBA ranges associated with a single recommended path. If the data size of the management information or the number of LBA ranges to be managed is limited, an access path that is not a recommended path may be used for access to an LBA range that is not managed. If an access path that is not a recommended path is used, access performance may be reduced.

### SUMMARY

According to an aspect of the present invention, provided is a storage control device including a plurality of controllers and a plurality of storage units. The plurality of controllers are associated with a plurality of first storage regions assigned to one or more recording media. The controllers are configured to control access to first storage regions associated with the respective controllers. The plurality of storage units are provided for the respective controllers. Each of the storage units has a second storage region to which unit storage regions secured in the plurality of first storage regions are assigned. Each of the unit storage regions is associated with any one of the controllers. Each of the controllers includes a processor configured to assign a new unit storage region to the second storage region. The processor is configured to change, upon the assignment of the new unit storage region, arrangement of the unit storage regions assigned to the second storage region so that unit storage regions associated with a same controller are continuously arranged in the second storage region.

The objects and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a storage system according to a first embodiment;

FIG. 2 is a diagram illustrating a storage system according to a second embodiment;

FIG. 3 is a diagram illustrating the storage system according to the second embodiment;

FIG. 4 is a diagram illustrating an example of hardware that achieves functions of a server according to the second embodiment;

FIG. 5 is a diagram illustrating functions of a controller included in a storage control device according to the second embodiment;

FIG. 6 is a diagram illustrating an example of equalization information held by the controller according to the second embodiment;

FIG. 7 is a diagram illustrating a process of assigning RLU regions performed by the controller according to the second embodiment;

FIG. 8 is a diagram illustrating an example of recommended path information held by the controller according to the second embodiment;

FIG. 9 is a diagram illustrating an example of segment information held by the controller according to the second embodiment;

FIG. 10 is a diagram illustrating an example of threshold information held by the controller according to the second embodiment;

FIG. 11 is a diagram illustrating the process of assigning RLU regions performed by the controller according to the second embodiment and a resulting number of segments;

FIG. 12 is a diagram illustrating the process of assigning RLU regions performed by the controller according to the second embodiment and a resulting number of segments;

FIG. 13 is a diagram illustrating the process of assigning RLU regions performed by the controller according to the second embodiment and a resulting number of segments;

FIG. 14 is a flowchart of a process executed by the controller according to the second embodiment; and

FIG. 15 is a flowchart of a process executed by the controller according to the second embodiment.

### DESCRIPTION OF EMBODIMENTS

Hereinafter, embodiments are described with reference to the accompanying drawings. In the present specification and the drawings, elements that have similar functions are represented by similar reference numerals, and a repetitive description is omitted.

### First Embodiment

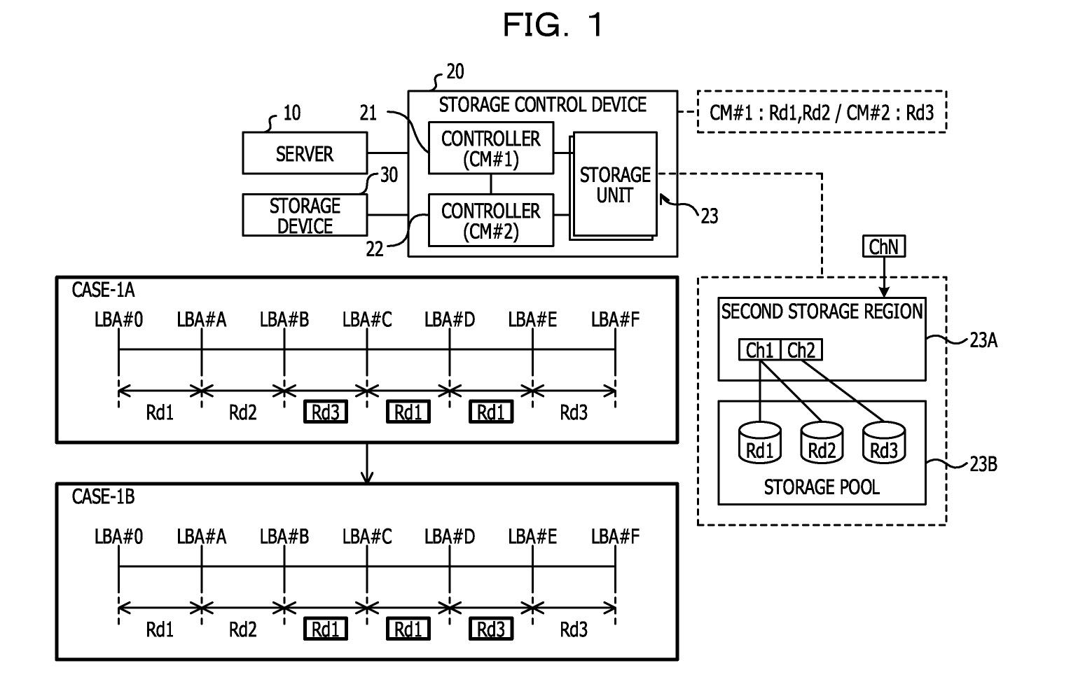

A first embodiment is described with reference to FIG. 1. FIG. 1 is a diagram illustrating a storage system according to the first embodiment.

As illustrated in FIG. 1, the storage system according to the first embodiment includes a server 10, a storage control device 20, and a storage device 30.

The server 10 accesses, through the storage control device 20, one or more recording media included in the storage device 30. As the recording media, magnetic recording media such as HDDs and magnetic tapes, optical recording media such as optical discs, and semiconductor memories such as solid state drives (SSDs) may be used, for example. A RAID device is an example of the storage device 30.

The storage control device 20 includes controllers 21 and 22 and storage units 23. Although the number of the controllers (controllers 21 and 22) included in the storage control device 20 is two in an example illustrated in FIG. 1, the storage control device 20 may include three or more controllers. In the example illustrated in FIG. 1, the controller 21 is represented by CM#1 and the controller 22 is represented by CM#2.

The storage units 23 are volatile storage devices such as random access memories (RAMs) or nonvolatile storage devices such as HDDs or flash memories. The controllers 21 and 22 are processors such as central processing units (CPUs) or digital signal processors (DSPs), for example. The controllers 21 and 22, however, may be electronic circuits such as application specific integrated circuits (ASICs) or field programmable gate arrays (FPGAs). The controllers 21 and 22 execute a program stored in the storage units 23 or another memory, for example.

The controllers 21 and 22 are associated with a plurality of first storage regions Rd1, Rd2, and Rd3 assigned to the one or more recording media included in the storage device 30. The aforementioned physical LUs and the aforementioned RLUs are examples of the first storage regions. The plurality of first storage regions Rd1, Rd2, and Rd3 are registered in a storage pool 23B managed by the controllers 21 and 22. Although the number of the first storage regions (Rd1, Rd2, and Rd3) registered in the storage pool 23B in the example illustrated in FIG. 1 is three, the number of first storage regions which the storage pool 23B may register may be two or less or four or more.

The controllers 21 and 22 control access to corresponding first storage regions among Rd1, Rd2, and Rd3. In the example illustrated in FIG. 1, the controller 21 (CM#1) is associated with the first storage regions Rd1 and Rd2, and the controller 22 (CM#2) is associated with the first storage region Rd3. Thus, the controller 21 controls access to the first storage regions Rd1 and Rd2, while the controller 22 controls access to the first storage region Rd3.

The storage units 23 store therein information of the storage pool 23B and information of the first storage regions Rd1, Rd2, and Rd3 registered in the storage pool 23B. In addition, the storage units 23 store therein information of a second storage region 23A. The second storage region 23A is a logical storage region (logical volume). The aforementioned TPV is an example of the second storage region. Although only one second storage region 23A is illustrated in the example of FIG. 1, two or more second storage regions 23A may be included in the storage units 23.

Unit storage regions Ch1, Ch2, . . . that each have a preset size are assigned to the second storage region 23A. In addition, a part or whole of the physical region included in the first storage regions Rd1, Rd2, and Rd3 is assigned to the unit storage regions Ch1, Ch2, . . . . In the example of FIG. 1, a part or whole of the physical region included in the first storage regions Rd1 and Rd2 is assigned to the unit storage region Ch1, while a part or whole of the physical region included in the first storage region Rd3 is assigned to the unit storage region Ch2. A unit block (chunk) assigned to the aforementioned TPV is an example of the unit storage regions.

As described above, for the respective controllers 21 and 22, the unit storage regions Ch1, Ch2, . . . that are secured in one or more of the first storage regions associated with the respective controllers 21 and 22 among Rd1, Rd2, and Rd3, are assigned to the second storage region 23A.

In the example illustrated in FIG. 1, the unit storage region Ch1 secured in the first storage regions Rd1 and Rd2 which the controller 21 may access coexists in the second storage region 23A with the unit storage region Ch2 secured in the first storage region Rd3 which the controller 22 may access. That is, the storage control device 20 permits a state in which the unit storage region Ch1 that provides an access path passing through the controller 21 and the unit storage region Ch2 that provides an access path passing through the controller 22 coexist in the second storage region 23A.

When assigning unit storage regions ChN to the second storage region 23A, the controllers 21 and 22 change arrangement of the unit storage regions Ch1, Ch2, . . . , ChN so that a plurality of unit storage regions associated with the same controller are continuously arranged in the second storage region 23A.

For example, a case where an LBA range of LBA#B to LBA#C in the second storage region 23A is an unassigned region and the unit storage region ChN secured in the first storage region Rd3 is assigned to the unassigned region is considered. CASE-1A indicates a state immediately after the unit storage region ChN is assigned, while CASE-1B indicates a state after the arrangement of the unit storage regions Ch1, Ch2, . . . , ChN is changed. CASE-1A and CASE-1B indicate relationships between LBA ranges and the first storage regions associated with the unit storage regions assigned to the LBA ranges.

In an example of CASE-1A, a unit storage region within the first storage region Rd1 is assigned to an LBA range of LBA#0 to LBA#A, and a unit storage region within the first storage region Rd2 is assigned to an LBA range of LBA#A to LBA#B. In addition, a unit storage region within the first storage region Rd3 is assigned to the LBA range of LBA#B to LBA#C, and a unit storage region within the first storage region Rd1 is assigned to an LBA range of LBA#C to LBA#D. Furthermore, a unit storage region within the first storage region Rd1 is assigned to an LBA range of LBA#D to LBA#E, and a unit storage region within the first storage region Rd3 is assigned to an LBA range of LBA#E to LBA#F.

If a first access path that passes through the controller 21 and a second access path that passes through the controller 22 are managed for the LBA ranges, management information is as follows. In the example of CASE-1A, the management information includes information in which an LBA range of LBA#0 to LBA#B is associated with the first access path and the LBA range of LBA#B to LBA#C is associated with the second access path. In addition, the management information includes information in which an LBA range of LBA#C to LBA#E is associated with the first access path and the LBA range of LBA#E to LBA#F is associated with the second access path. In this case, the number (number of segments) of the LBA ranges to be managed is four.

In an example of CASE-1B, the management information includes information in which an LBA range of LBA#0 to LBA#D is associated with the first access path and an LBA range of LBA#D to LBA#F is associated with the second access path. In this case, the number (number of segments) of the LBA ranges to be managed is two. Thus, if the number of segments is reduced, the amount of the management information may be reduced.

For example, if the number of segments which the server 10 may manage is three, one of the unit storage regions is not managed for the access path thereof in the state of CASE-1A, but all the unit storage regions are managed for the access paths thereof in the state of CASE-1B. In order to access a unit storage region that is not managed for the access path thereof, the server 10 selects an arbitrary access path. For example, the server 10 may notify the controller 21 of a request to access the unit storage region Ch2 associated with the first storage region Rd3. In this case, the controller 21 accesses (executes cross access) the first storage region Rd3 through the controller 22.

Thus, the controllers 21 and 22 change the arrangement of the unit storage regions Ch1, Ch2, . . . , ChN of the second storage region 23A so as to reduce the number of segments. The change may reduce the number of unit storage regions that are not managed among the unit storage regions Ch1, Ch2, . . . , ChN, and reduce the frequency of the cross access. A reduction in the access performance is suppressed by the reduction in the frequency of the cross access.

The first embodiment is described above.

### Second Embodiment

Next, a second embodiment is described.

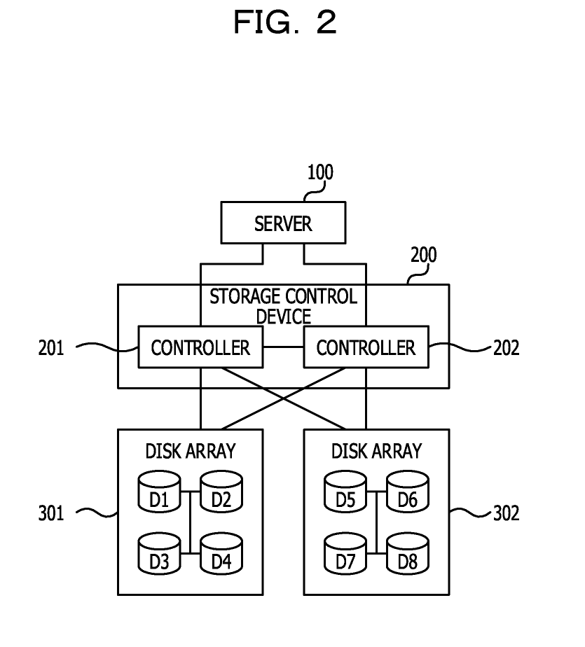

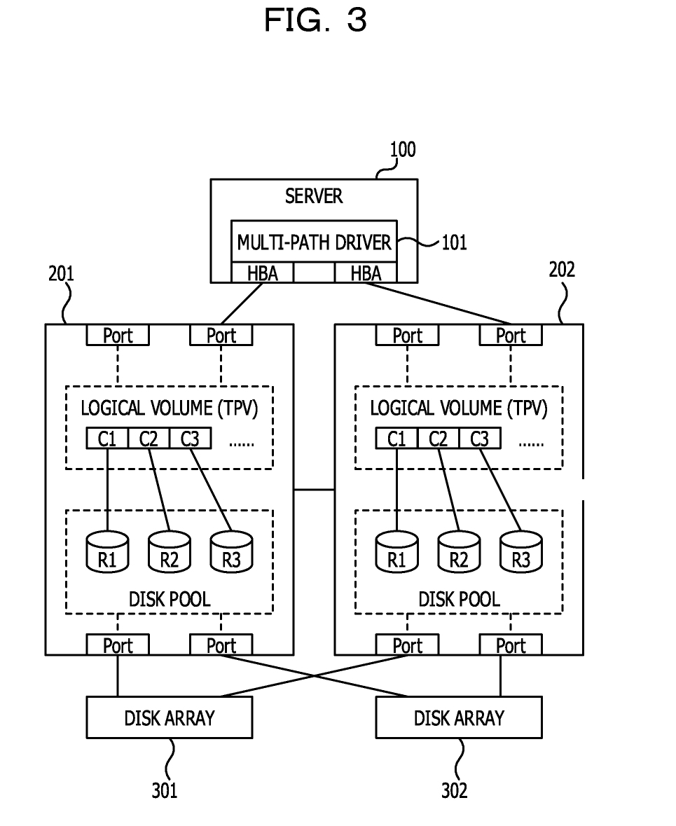

First, a storage system according to the second embodiment is described with reference to FIGS. 2 and 3. FIGS. 2 and 3 are diagrams illustrating the storage system according to the second embodiment.

As illustrated in FIG. 2, the storage system according to the second embodiment includes a server 100, a storage control device 200, and disk arrays 301 and 302.

The server 100 accesses the disk arrays 301 and 302 through the storage control device 200. The disk array 301 includes a plurality of recording media D1, D2, D3, and D4. The disk array 302 includes a plurality of recording media D5, D6, D7, and D8. As the recording media, magnetic recording media such as HDDs or magnetic tapes, optical recording media such as optical discs, or semiconductor memories such as SSDs may be used. RAID devices are an example of the disk arrays 301 and 302.

The storage control device 200 includes controllers 201 and 202. Although the number of the controllers (controllers 201 and 202) included in the storage control device 200 is two in an example illustrated in FIG. 2, the storage control device 200 may include three or more controllers. In the following description, the controller 201 may be represented by CM#1 and the controller 202 may be represented by CM#2 in some cases.

As illustrated in FIG. 3, the server 100 includes a multi-path driver 101 configured to manage access paths for access to physical regions of the disk arrays 301 and 302 through the storage control device 200. The server 100 includes a plurality of host bus adapters (HBAs). The HBAs are connected to ports included in the controllers 201 and 202 of the storage control device 200, respectively. The multi-path driver 101 accesses the controllers 201 and 202 through the HBAs. The multi-path driver 101 manages information of access paths (recommended paths) that are suitable for access to the physical regions.

Each of the controllers 201 and 202 manages a logical volume storing logical storage regions to be provided to the server 100 and a disk pool to be used to assign the physical regions of the disk arrays 301 and 302. In order to simplify the following description, a case where the logical volumes to be managed by the controllers 201 and 202 are TPVs is considered. In addition, a case where RAID groups R1, R2, and R3 formed by grouping the physical regions of the disk arrays 301 and 302 are registered in the disk pools is considered. Hereinafter, physical regions of the RAID groups Rk (k=1, 2, 3) are represented by RLU regions Rk.

It is assumed that the controller 201 is set so as to be able to access the RLU regions R1 and R2 and that the controller 202 is set so as to be able to access the RLU region R3. That is, a case where the controller 201 is responsible for the RLU regions R1 and R2 and the controller 202 is responsible for the RLU region R3 is considered. Hereinafter, the responsible controllers are represented by responsible CMs in some cases.

Units (referred to as chunks) of the logical storage regions are assigned to the TPVs. A part or whole of the RLU region is assigned to a chunk. In the example illustrated in FIG. 3, the chunks C1, C2, C3, . . . are assigned to the TPVs. The RLU region R1 is assigned to the chunk C1, the RLU region R2 is assigned to the chunk C2, and the RLU region R3 is assigned to the chunk C3.

The chunks are generated when the controller 201 or 202 receives, from the server 100, a command (write command) to request to write data. For example, if data with an amount larger than an RLU region assigned to an existing chunk is to be written, a new chunk is generated and data is written in an RLU region assigned to the new chunk.

In order for the server 100 to access data in the TPVs, the multi-path driver 101 executes a process of selecting an access path. For example, when the server 100 transmits, to the controller 201, a request to access the chunk C3 assigned with the RLU region R3 for which the controller 202 is responsible, the controller 201 executes the cross access, that is, accesses the RLU region R3 through the controller 202. Thus, the multi-path driver 101 selects an access path (recommended path) enabling the request for accessing the chunk C3 to be transmitted to the controller 202 and thereby suppresses the execution of the cross access.

The multi-path driver 101 uses, for example, the RR command to acquire information of recommended paths for LBA ranges of the TPVs. The multi-path driver 101 holds the acquired information of the recommended paths and uses the held information of the recommended paths to select an access path. Thus, by managing the information of the recommended paths for the LBA ranges, the multi-path driver 101 may select a recommended path even if a plurality of chunks, to which RLU regions having different responsible CMs are assigned, coexist in a single TPV.

The storage system according to the second embodiment is described above.

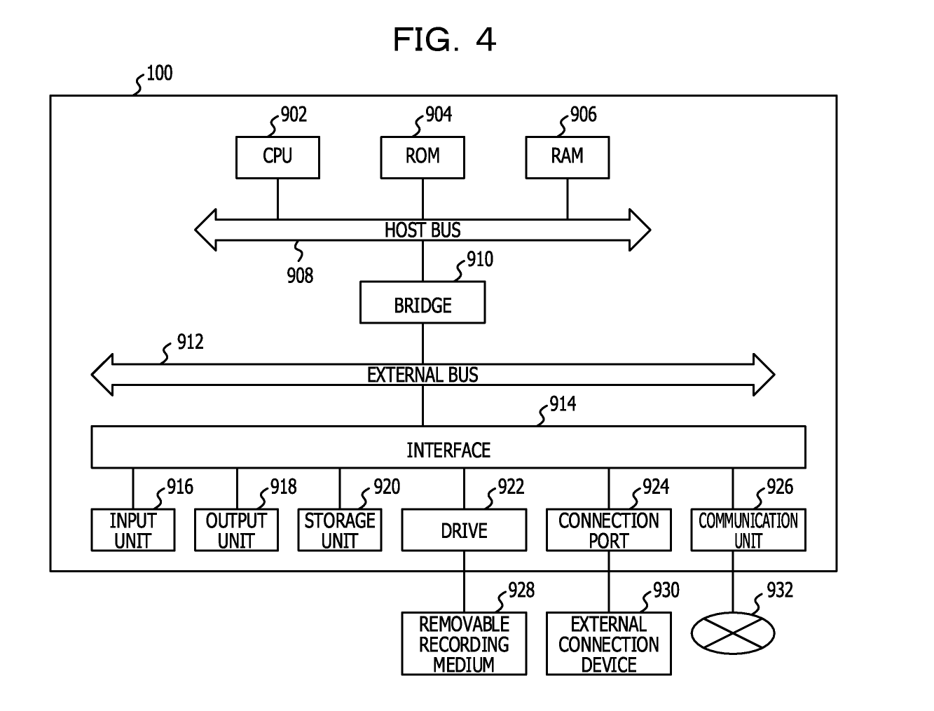

Next, hardware of the server 100 is described with reference to FIG. 4. FIG. 4 is a diagram illustrating an example of hardware that achieves functions of the server according to the second embodiment.

The functions of the server 100 may be achieved using hardware resources of an information processing device illustrated in FIG. 4. Specifically, the functions of the server 100 are achieved by controlling the hardware illustrated in FIG. 4 using a computer program.

As illustrated in FIG. 4, the hardware mainly includes a CPU 902, a read-only memory (ROM) 904, a RAM 906, a host bus 908, and a bridge 910. The hardware further includes an external bus 912, an interface 914, an input unit 916, an output unit 918, a storage unit 920, a drive 922, a connection port 924, and a communication unit 926.

The CPU 902 functions as an arithmetic processing device or a control device and controls a part or whole of the operation of the constituent elements of the server 100 in accordance with various programs stored in the ROM 904, the RAM 906, the storage unit 920, or a removable recording medium 928, for example. The ROM 904 is an example of a storage device storing a program to be executed by the CPU 902 and data to be used for calculation. The RAM 906 temporarily or permanently stores the program to be executed by the CPU 902 and various parameters that change upon the execution of the program.

The elements are connected to one another through the host bus 908 that enables high-speed data transfer. On the other hand, the host bus 908 is connected through, for example, the bridge 910 to the external bus 912 that provides relatively low-speed data transfer. As the input unit 916, a mouse, a keyboard, a touch panel, a touchpad, buttons, a switch, or a lever may be used. As the input unit 916, a remote controller that may transmit a control signal using an infrared ray or another radio wave may be used.

As the output unit 918, a display device such as a cathode ray tube (CRT), a liquid crystal display (LCD), a plasma display panel (PDP), or an electroluminescence display (ELD) is used, for example. In addition, as the output unit 918, an audio output device, such as a speaker or a headphone, or a printer may be used. The output unit 918 is a device configured to visually or audibly output information.

The storage unit 920 is a device configured to store therein various types of data. As the storage unit 920, a magnetic storage device such as an HDD is used, for example. In addition, as the storage unit 920, a semiconductor device such as a solid state drive (SSD) or a RAM disk, an optical storage device, or a magneto-optical storage device may be used.

The drive 922 is a device configured to read information stored in the removable recording medium 928 or write information in the removable recording medium 928. As the removable recording medium 928, a magnetic disk, an optical disc, a magneto-optical disc, a semiconductor memory, or the like is used, for example.

The connection port 924 is a port configured to connect the server 100 to an external connection device 930 and is, for example, an universal serial bus (USB) port, an IEEE1394 port, a small computer system interface (SCSI), an RS-232 port, an optical audio terminal, or the like. As the external connection device 930, a printer or the like is used, for example.

The communication unit 926 is a communication device configured to connect the server 100 to a network 932. As the communication unit 926, a wired communication circuit, a wireless local area network (LAN) communication circuit, a wireless USB (WUSB) communication circuit, an optical communication circuit, an optical communication router, an asymmetric digital subscriber line (ADSL) communication circuit, an ADSL communication router, a mobile phone network communication circuit, or the like is used, for example. The communication unit 926 is connected to the network 932 wirelessly or through a cable. The network 932 includes the Internet, a LAN, a broadcasting network, and a satellite communication line.

The hardware of the server 100 is described above. Functions of the controller 201 and the controller 202 included in the storage control device 200 may be achieved using a part or whole of the hardware illustrated in FIG. 4, thus, a description of hardware thereof is omitted.

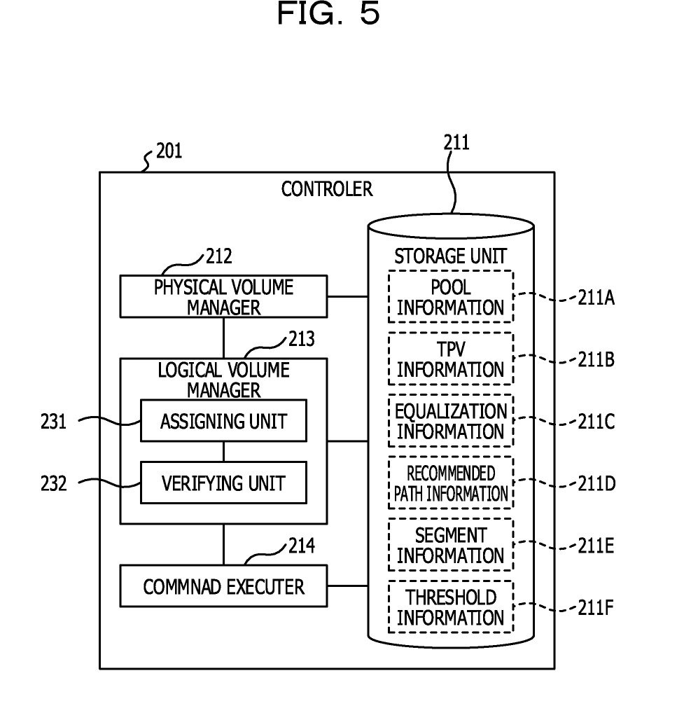

Next, the functions of the controller 201 are described with reference to FIG. 5. FIG. 5 is a diagram illustrating the functions of the controller included in the storage control device according to the second embodiment. Note that the functions of the controller 202 are similar to the functions of the controller 201, thus, a description thereof is omitted.

As illustrated in FIG. 5, the controller 201 includes a storage unit 211, a physical volume manager 212, a logical volume manager 213, and a command executer 214.

Functions of the storage unit 211 may be achieved using the aforementioned RAM 906, the aforementioned storage unit 920, and the like. Functions of the physical volume manager 212, logical volume manager 213, and command executer 214 may be achieved using the aforementioned CPU 902 and the like.

The storage unit 211 stores therein pool information 211A, TPV information 211B, equalization information 211C, recommended path information 211D, segment information 211E, and threshold information 211F. The pool information 211A includes information on the disk pools to be managed and information on RLU regions registered in the disk pools. The pool information 211A further includes information in which the RLU regions are associated with respective responsible CMs. The TPV information 211B includes information on the TPVs to be managed and information on chunks assigned to the TPVs. The TPV information 211B further includes information in which the chunks are associated with respective RLU regions.

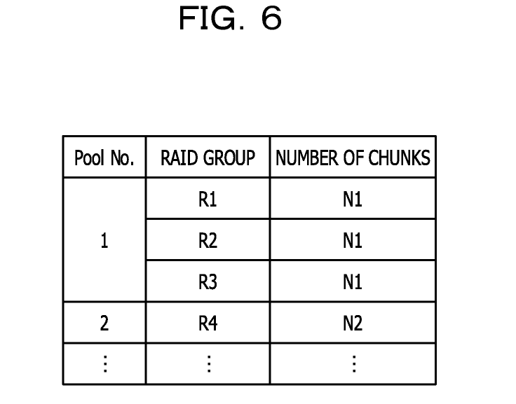

The equalization information 211C, the recommended path information 211D, the segment information 211E, and the threshold information 211F are described with reference to FIGS. 6 to 10.

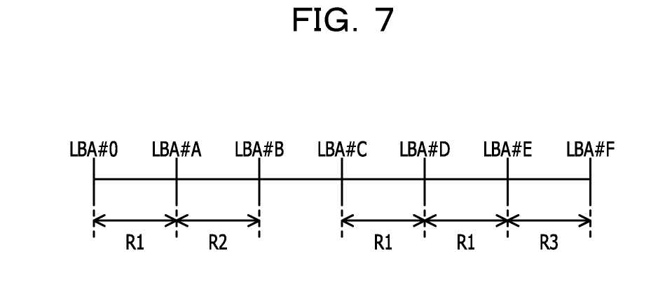

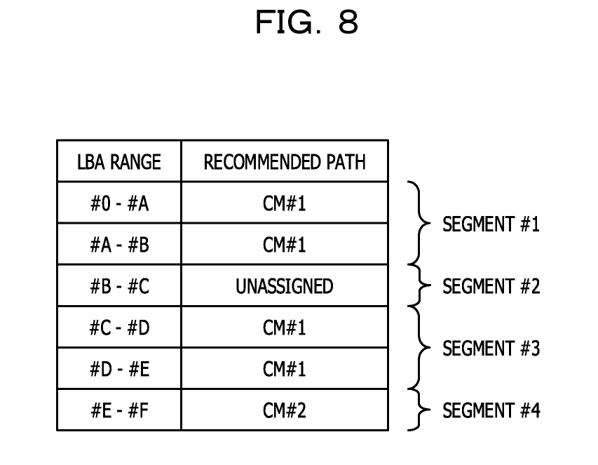

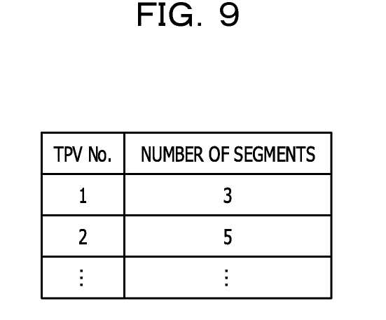

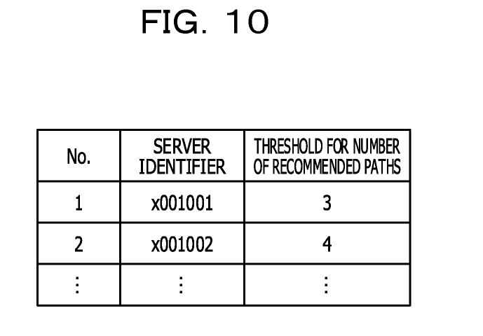

FIG. 6 is a diagram illustrating an example of the equalization information held by the controller according to the second embodiment. FIG. 7 is a diagram illustrating a process of assigning RLU regions performed by the controller according to the second embodiment. FIG. 8 is a diagram illustrating an example of the recommended path information held by the controller according to the second embodiment. FIG. 9 is a diagram illustrating an example of the segment information held by the controller according to the second embodiment. FIG. 10 is a diagram illustrating an example of the threshold information held by the controller according to the second embodiment.

The equalization information 211C is used for assignments of a RLU region to a chunk. The equalization information 211C is assignment management information to be used to manage the numbers of chunks such that the numbers of the chunks, to which RLU regions of respective RAID groups registered in a disk pool are assigned, are equal to one another as far as possible. For example, an equalization assignment table illustrated in FIG. 6 is an example of the equalization information 211C.

As illustrated in FIG. 6, in the equalization assignment table, information (Pool No.) that identifies a disk pool, an identifier of a RAID group, and the number of chunks are associated. In the equalization assignment table, the number of chunks is the number of the chunks to which the RLU regions of the RAID group are assigned. When an RLU region is to be assigned to a chunk, a RAID group having the RLU region to be assigned is selected in a cyclic manner such that the numbers of the chunks assigned to the RLU regions in the disk pool are equal to one another as far as possible, and an RLU region of the selected RAID group is assigned to the chunk.

In the example illustrated in FIG. 6, the numbers of chunks to which RLU regions of the RAID groups R1, R2, and R3 included in a disk pool of Pool No. “1” are assigned are N1, respectively, and thus the assignments for the RAID groups are equalized. The number of chunks to which RLU regions are assigned is increased when a chunk is registered in a TPV and an RLU region is assigned to the chunk. When a chunk is deleted from the TPV, the number of chunks that is associated with a RAID group having an RLU region assigned to the chunk is reduced.

The recommended path information 211D is path management information to be used to manage recommended paths. As described above, a responsible CM exists for each RLU region. An access path for access to an RLU region through the responsible CM is a recommended path. When a chunk is assigned to a TPV, an RLU region is assigned to the chunk. Thus, as illustrated in FIG. 7, an LBA range to which the chunk is assigned is associated with the RLU region assigned to the chunk. In addition, based on a relationship between the RLU region and a CM responsible for the RLU region, the LBA range is associated with the responsible CM (recommended path).

In an example illustrated in FIG. 7, a chunk to which the RLU region R1 is assigned exists in the LBA range of LBA#0 to LBA#A, and a chunk to which the RLU region R2 is assigned exists in the LBA range of LBA#A to LBA#B. The LBA range of LBA#B to LBA#C is an unassigned region. A chunk to which the RLU region R1 is assigned exists in the LBA range of LBA#C to LBA#E, and a chunk to which the RLU region R3 is assigned exists in the RLU region of LBA#E to LBA#F. In this case, association relationships between the LBA ranges and recommended paths are illustrated in FIG. 8. A recommended path table illustrated in FIG. 8 is an example of the recommended path information 211D.

A continuous LBA range that is associated with the same recommended path is referred to as a segment. In the example illustrated in FIG. 8, the LBA range of LBA#0 to LBA#B is associated with a recommended path passing through the CM#1 and forms a segment#1. The LBA range of LBA#C to LBA#E is associated with a recommended path passing through the CM#1 and forms a segment#3. The unassigned region forms a segment#2. The LBA range of LBA#E to LBA#F is associated with a recommended path passing through the CM#2 and forms a segment#4. The recommended path information 211D in which the LBA regions are associated with the recommended paths provides information on segments for each of the TPVs.

The segment information 211E is management information to be used to manage the number of segments for each of the TPVs. A TPV management table illustrated in FIG. 9 is an example of the segment information 211E. As described above, the number of segments may be counted for each of the TPVs by referencing the recommended path information 211D. The TPV management table represents the results of the counting. As illustrated in FIG. 9, in the TPV management table, the number of the segments is associated with information (TPV No.) identifying the TPV. The segment information 211E is updated when a detail of the recommended path information 211D is changed, such as when a chunk is assigned to a TPV.

The threshold information 211F is management information to be used to manage the number of recommended paths which the server 100 may hold. A threshold management table illustrated in FIG. 10 is an example of the threshold information 211F. In the threshold management table, a server identifier (server identification information) that identifies a server 100 is associated with a threshold for the number of recommended paths. In the example illustrated in FIG. 10, the number (threshold for the number of recommended paths) of recommended paths which a server 100 with a server identifier x001001 may hold is set to three. The number (threshold for the number of recommended paths) of recommended paths which a server 100 with a server identifier x001002 may hold is set to four. Each server 100 holds information of recommended paths on a segment basis. Thus, the threshold for the number of recommended paths represents an upper limit of the number of segments which a server 100 may manage.

Refer to FIG. 5 again. The physical volume manager 212 manages the pool information 211A. For example, the physical volume manager 212 executes a process of registering an RLU region in a disk pool, a process of managing usage statuses of RLU regions, and the like.

The logical volume manager 213 manages the TPV information 211B. For example, the logical volume manager 213 executes a process of registering a chunk in a TPV, a process of assigning an RLU region to a chunk, a process of changing arrangement of chunks registered in the TPVs, and the like. In addition, the logical volume manager 213 executes a process of updating the equalization information 211C, the recommended path information 211D, the segment information 211E, and the like.

In order to execute the aforementioned processes, the logical volume manager 213 has an assigning unit 231 and a verifying unit 232. The assigning unit 231 executes the process of registering a chunk in a TPV, the process of assigning an RLU to a chunk, and the like. The verifying unit 232 executes the process of arrangement of chunks registered in the TPVs, and the like.

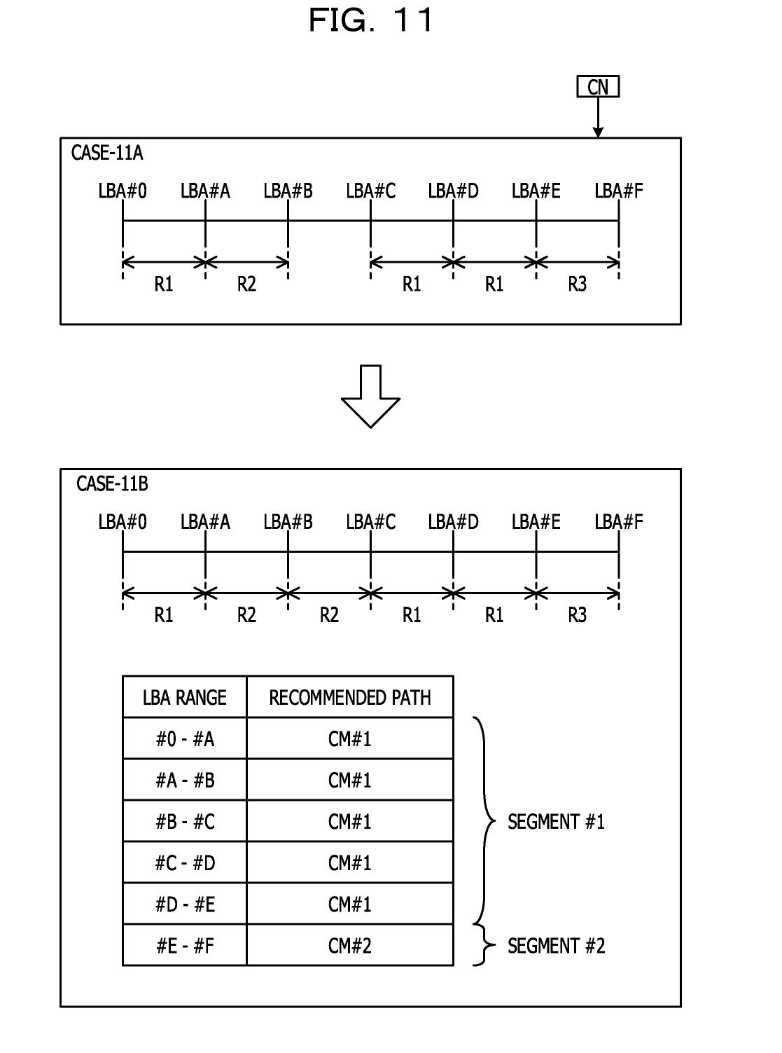

Functions of the assigning unit 231 and verifying unit 232 are described below with reference to FIGS. 11 to 13.

The following description assumes that the TPVs are in the states illustrated in FIGS. 7 and 8. FIGS. 11 to 13 are diagrams illustrating the process of assigning RLU regions performed by the storage control device according to the second embodiment and a resulting number of segments.

Refer to FIG. 11. In an example of CASE-11A, a chunk to which the RLU region R1 is assigned exists in the LBA range of LBA#0 to LBA#A, and a chunk to which the RLU region R2 is assigned exists in the LBA range of LBA#A to LBA#B. The LBA range of LBA#B to LBA#C is an unassigned region. A chunk to which the RLU region R1 is assigned exists in the LBA range of LBA#C to LBA#E, and a chunk to which the RLU region R3 is assigned exists in the LBA range of LBA#E to LBA#F. In this case, the number of segments is four.

Assume that a chunk CN, to which the RLU region R2 is assigned, is to be assigned to the LBA range of LBA#B to LBA#C which is the unassigned region. Based on this assumption, assignment states of the chunks and association relationships between the LBA ranges and recommended paths are represented in CASE-11B. On the upper side of CASE-11B, association relationships between the LBA ranges and the RLU regions are illustrated.

The assigning unit 231 assigns the chunk CN, to which the RLU region R2 is assigned, to the LBA range of LBA#B to LBA#C which is the unassigned region. As illustrated on the upper side of CASE-11B, the RLU region R2 is associated with the LBA range of LBA#B to LBA#C by assigning the chunk CN to a TPV. The verifying unit 232 updates the recommended path information 211D representing the relationships between the LBA ranges and the recommended paths, as illustrated on the lower side of CASE-11B.

In the example illustrated in FIG. 11, since the chunk CN is assigned to the LBA range of LBA#B to LBA#C, recommended paths associated with an LBA range of LBA#0 to LBA#E is access paths that pass through the same responsible CM (CM#1). The verifying unit 232 extracts continuous LBA ranges (segments) associated with the recommended paths passing through the same responsible CM and counts the number of the extracted segments. In addition, the verifying unit 232 updates the segment information 211E on the basis of the counted number of the segments. In the example illustrated in FIG. 11, the number of the segments is two.

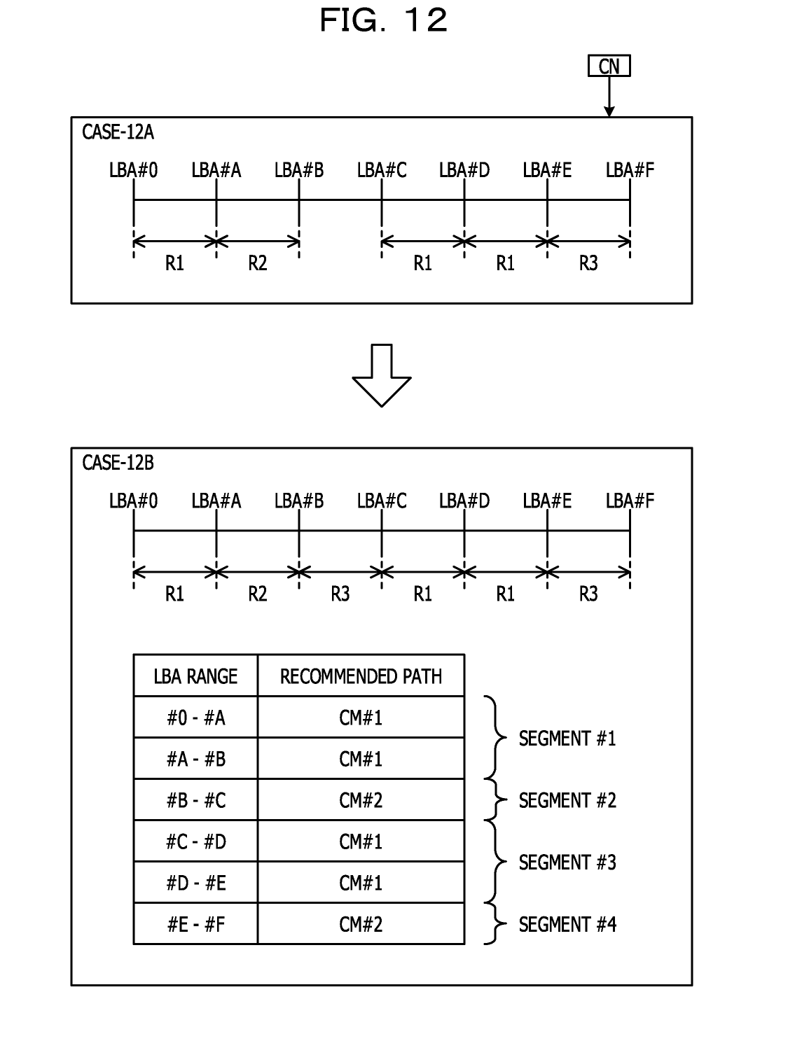

The verifying unit 232 references the threshold information 211F and acquires a threshold for the number of recommended paths for the server 100 which accesses a TPV to which the chunk CN is assigned. The verifying unit 232 compares the acquired threshold for the number of the recommended paths with the number of the segments, which is indicated by the segment information 211E after the update. If the number of the segments is larger than the threshold for the number of the recommended paths, the verifying unit 232 changes an arrangement of chunks assigned to the TPV. For example, if the threshold for the number of recommended paths is three, the number of the segments is two in the example illustrated in FIG. 11 and the arrangement of the chunks is not changed. On the other hand, if the chunk CN is assigned to the RLU region R3 as illustrated in FIG. 12, a state is different from the state illustrated in FIG. 11.

Refer to FIG. 12. In an example illustrated in FIG. 12, the assigning unit 231 assigns, to the LBA range of LBA#B to LBA#C which is the unassigned region, the chunk CN to which the RLU region R3 is assigned. Since the chunk CN is assigned to the TPV, the RLU region R3 is associated with the LBA range of LBA#B to LBA#C as represented on the upper side of CASE-12B. The verifying unit 232 updates the recommended path information 211D representing relationships between the LBA ranges and the recommended paths, as represented on the lower side of CASE-12B.

In the example illustrated in FIG. 12, after the chunk CN is assigned to the LBA range of LBA#B to LBA#C, recommended paths associated with the LBA range of LBA#0 to LBA#B are treated as the access paths that pass through the same responsible CM (CM#1). A recommended path associated with the LBA range of LBA#B to LBA#C is treated as an access path that passes through the same responsible CM (CM#2). Recommended paths associated with the LBA range of LBA#C to LBA#E are treated as the access paths that pass through the same responsible CM (CM#1). A recommended path associated with the LBA range of LBA#E to LBA#F is treated as the access path that passes through the same responsible CM (CM#2).

The verifying unit 232 extracts continuous LBA ranges (segments) associated with the recommended paths passing through the same responsible CM and counts the number of the extracted segments. In addition, the verifying unit 232 updates the segment information 211E on the basis of the counted number of the segments. In the example illustrated in FIG. 12, the number of the segments is four.

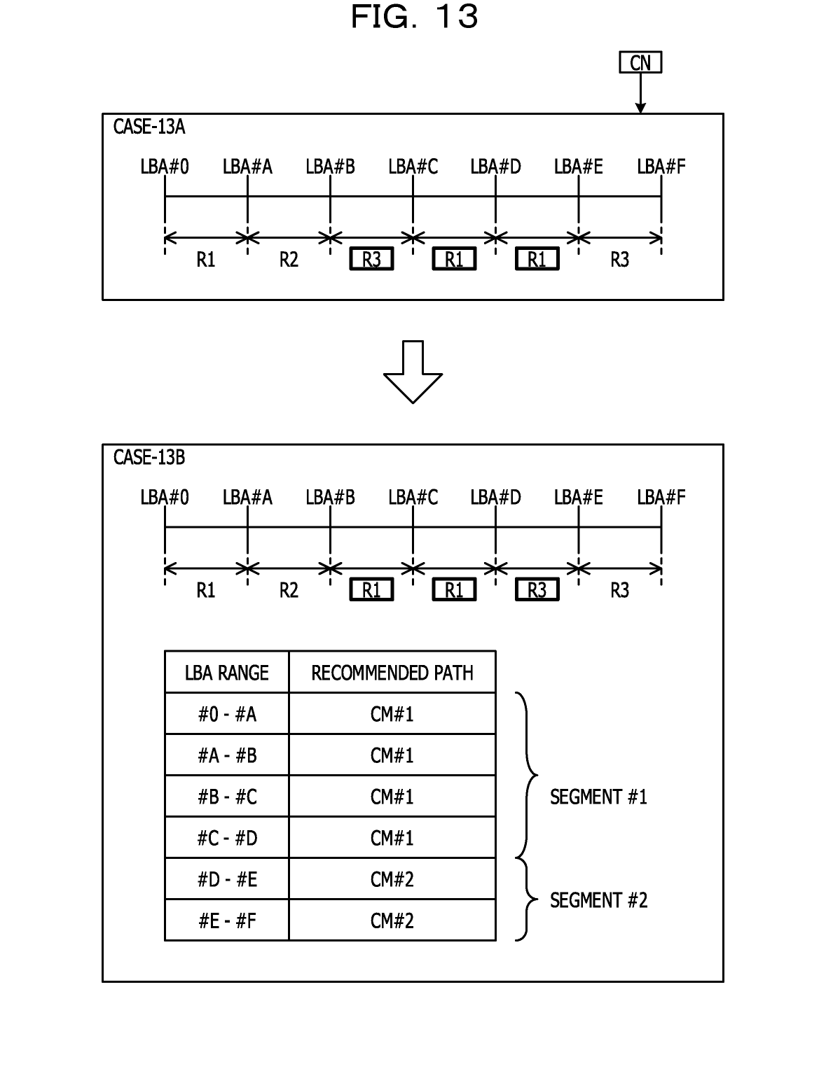

The verifying unit 232 references the threshold information 211F and acquires a threshold for the number of recommended paths for the server 100 which accesses a TPV to which the chunk CN is assigned. The verifying unit 232 compares the acquired threshold for the number of the recommended paths with the number of the segments, which is indicated by the segment information 211E after the update. If the threshold for the number of the recommended paths is three, the number of the segments is four in the example illustrated in FIG. 12 and the verifying unit 232 changes the arrangement of the chunks assigned to the TPV, as illustrated in FIG. 13. CASE-13A represents assignment states when the chunk CN, to which the RLU region R3 is assigned, is assigned to the TPV.

The CM that is responsible for the RLU region R3 assigned to the chunk CN is CM#2. The RLU regions R1 and R2 for which CM#1 is responsible are assigned to the LBA range of LBA#0 to LBA#B that precedes the LBA range of LBA#B to LBA#C to which the chunk CN is assigned. The RLU region R1 for which CM#1 is responsible is assigned to the LBA range of LBA#C to LBA#E that succeeds the LBA range of LBA#B to LBA#C to which the chunk CN is assigned.

Since CM#2 is responsible for the chunk CN, the LBA range of LBA#0 to LBA#B and the LBA range of LBA#C to LBA#E, which are associated with the same responsible CM, are not continuous due to the assignment of the chunk CN, and the segments are separated from each other. As a result, the number of the segments becomes large. Therefore, the verifying unit 232 changes the assignments of the LBA ranges so that a continuous LBA range associated with a single responsible CM becomes wider.

For example, as represented in CASE-13B, the verifying unit 232 migrates a chunk assigned to the LBA range of LBA#C to LBA#D to the LBA range of LBA#B to LBA#C. The verifying unit 232 migrates a chunk assigned to the LBA range of LBA#D to LBA#E to the LBA range of LBA#C to LBA#D. The verifying unit 232 migrates a chunk assigned to the LBA range of LBA#B to LBA#C to the LBA range of LBA#D to LBA#E. Thus, the verifying unit 232 updates the TPV information 211B.

By changing the arrangement of the chunks as described above, an LBA range of LBA#0 to LBA#D becomes a continuous LBA range associated with the same responsible CM (CM#1). In addition, an LBA range of LBA#D to LBA#F becomes a continuous LBA range associated with the same responsible CM (CM#2). The verifying unit 232 updates the recommended path information 211D on the basis of details of the changed arrangement. The verifying unit 232 counts the number of the segments. The verifying unit 232 updates the segment information 211E on the basis of the counted number of the segments. In the example illustrated in FIG. 13, the number of the segments is two.

The verifying unit 232 references the threshold information 211F and acquires a threshold for the number of recommended paths. The verifying unit 232 compares again the acquired threshold for the number of recommended paths with the number of the segments, which is indicated by the segment information 211E after the update. If the number of the segments is larger than the threshold for the number of recommended paths, the verifying unit 232 changes the arrangement of the chunks assigned to the TPV again. In the example illustrated in FIG. 13, since the number of the segments is two, the verifying unit 232 completes the process of changing the arrangement due to the assignment of the chunk CN. Then, the verifying unit 232 notifies the server 100 of SENSE requesting to rebuild multiple paths. When multiple paths are rebuilt, the verifying unit 232 provides, to the server 100, information of recommended paths on the basis of the recommended path information 211D after the update.

Refer to FIG. 5 again. The command executer 214 executes a command received from the server 100. For example, upon receiving a write command from the server 100, the command executer 214 references the TPV information 211B and recognizes an RLU region assigned to a chunk in which data is to be written. Then, the command executer 214 writes the data in the recognized RLU region.

Upon receiving a read command from the server 100, the command executer 214 references the TPV information 211B and recognizes an RLU region assigned to a chunk from which data is to be read. Then, the command executer 214 reads the data from the recognized RLU region. Upon receiving an RR command from the server 100, the command executer 214 references the recommended path information 211D and provides, to the server 100, information of a recommended path for each of the LBA ranges.

The functions of the controller 201 are described above.

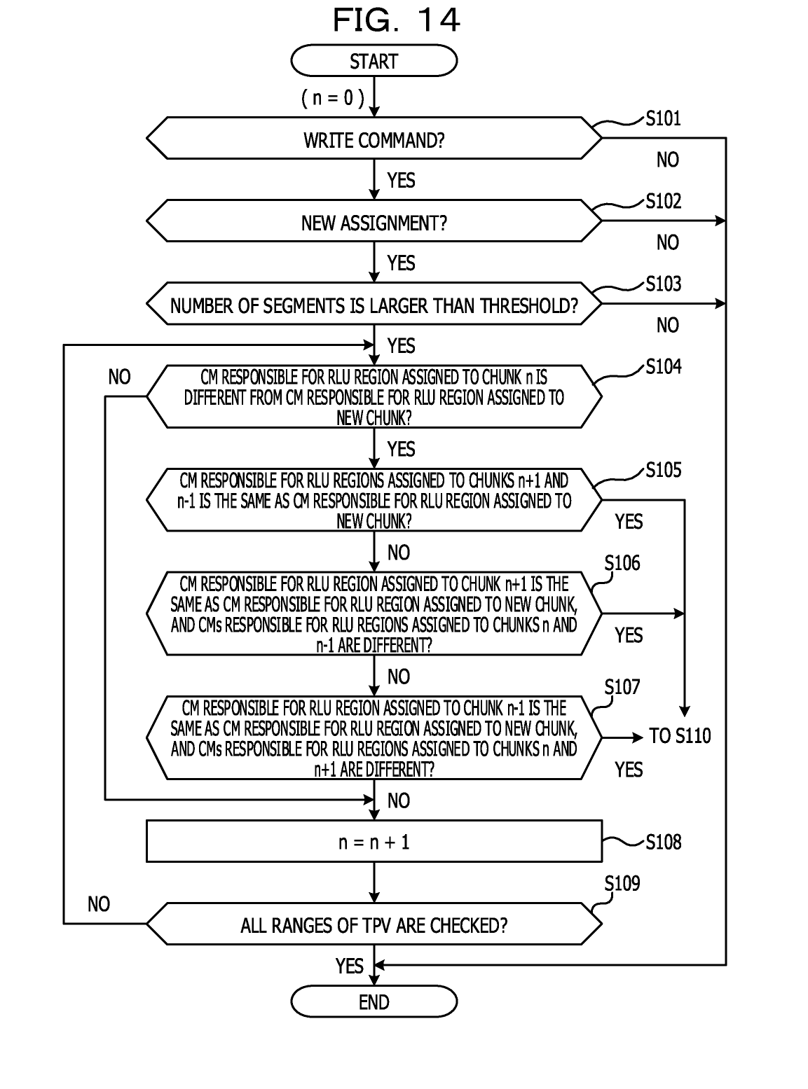

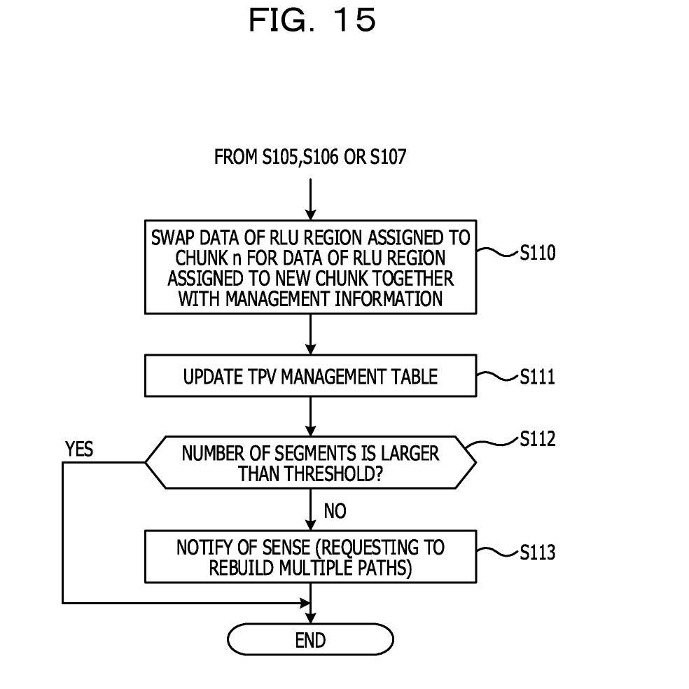

Next, the flow of a process executed by the controller 201 is described with reference to FIGS. 14 and 15. Note that the flow of a process executed by the controller 202 is similar to the process executed by the controller 201, thus, a description thereof is omitted. The flow of a process related to an assignment of a chunk is mainly described below.

FIGS. 14 and 15 are flowcharts of the process executed by the controller included in the storage control device according to the second embodiment. Before the start of the process illustrated in FIGS. 14 and 15, an index n is set to 0. Note that a chunk n represents an n-th chunk.

In S101, the command executer 214 determines whether or not the command executer 214 has received a write command from the server 100. If the command executer 214 has received the write command, the process proceeds to S102. If the command executer 214 has not received the write command, the process illustrated in FIGS. 14 and 15 is terminated. In this case, a process of executing a command, a process of responding about a status, and the like are executed, for example.

In S102, the logical volume manager 213 determines whether to assign a new chunk to a TPV and assign an RLU region to the new chunk. For example, if the size of an RLU region assigned to an existing chunk is smaller than data to be written in accordance with the write command received from the server 100, the logical volume manager 213 assigns a new chunk to the TPV.

If the logical volume manager 213 assigns a new chunk to a TPV and assigns an RLU region to the new chunk, the process proceeds to S103. On the other hand, if the logical volume manager 213 does not assign a new chunk to a TPV, the process illustrated in FIGS. 14 and 15 is terminated. In this case, the process of executing a command, the process of responding about a status, and the like are executed, for example.

In S103, the logical volume manager 213 determines whether or not the number of segments is larger than a threshold for the number of recommended paths. For example, the logical volume manager 213 assigns the new chunk to the TPV and updates the recommended path information 211D. The logical volume manager 213 references the recommended path information 211D after the update, counts the number of continuous LBA ranges associated with the same responsible CM, and calculates the number of the segments. Then, the logical volume manager 213 updates the segment information 211E on the basis of the calculated number of the segments.

The logical volume manager 213 compares the number of the segments, which is represented by the segment information 211E after the update, with the threshold for the number of recommended paths, which is represented by the threshold information 211F. If the logical volume manager 213 determines that the number of the segments is larger than the threshold for the number of recommended paths, the process proceeds to S104. On the other hand, if the logical volume manager 213 determines that the number of the segments is not larger than the threshold for the number of recommended paths, the process illustrated in FIGS. 14 and 15 is terminated. In this case, the process of executing a command, the process of responding about a status, and the like are executed, for example.

In S104, the logical volume manager 213 determines whether or not a CM that is responsible for an RLU region assigned to the chunk n is different from a CM that is responsible for the RLU region assigned to the new chunk. If the CM that is responsible for the RLU region assigned to the chunk n is different from the CM that is responsible for the RLU region assigned to the new chunk, the process proceeds to S105. On the other hand, if the CM that is responsible for the RLU region assigned to the chunk n is the same as the CM that is responsible for the RLU region assigned to the new chunk, the process proceeds to S108.

In S105, the logical volume manager 213 determines whether or not a CM that is responsible for RLU regions assigned to chunks n+1 and n−1 is the same as the CM that is responsible for the RLU region assigned to the new chunk. If the CM that is responsible for the RLU regions assigned to the chunks n+1 and n−1 is the same as the CM that is responsible for the RLU region assigned to the new chunk, the process proceeds to S110 illustrated in FIG. 15. On the other hand, if the CM that is responsible for the RLU regions assigned to the chunks n+1 and n−1 is not the same as the CM that is responsible for the RLU region assigned to the new chunk, the process proceeds to S106.

In S106, the logical volume manager 213 determines whether or not the following first and second requirements are satisfied. The first requirement is that “the CM that is responsible for the RLU region assigned to the chunk n+1 is the same as the CM that is responsible for the RLU region assigned to the new chunk”. The second requirement is that “the CMs that are responsible for the RLU regions assigned to the chunks n and n−1 are different”. If the aforementioned first and second requirements are satisfied, the process proceeds to S110 illustrated in FIG. 15. On the other hand, if the aforementioned first or second requirement is not satisfied, the process proceeds to S107.

In S107, the logical volume manager 213 determines whether or not the following third and fourth requirements are satisfied. The third requirement is that “the CM that is responsible for the RLU region assigned to the chunk n−1 is the same as the CM that is responsible for the RLU region assigned to the new chunk”. The fourth requirement is that “the CMs that are responsible for the RLU regions assigned to the chunks n and n+1 are different”. If the aforementioned third and fourth requirements are satisfied, the process proceeds to S110 illustrated in FIG. 15. On the other hand, if the aforementioned third or fourth requirement is not satisfied, the process proceeds to S108.

In S108, the logical volume manager 213 increments the index n by one. That is, the logical volume manager 213 changes the chunk to be checked.

In S109, the logical volume manager 213 determines whether or not all ranges (all chunks assigned to the TPV) of the TPV have been checked (or whether or not the processes of S104 and later have been executed). If the logical volume manager 213 completes the checking of all the ranges of the TPV, the process illustrated in FIGS. 14 and 15 is terminated. In this case, the process of executing a command, the process of responding about a status, and the like are executed, for example. On the other hand, if the logical volume manager 213 does not complete the checking of all the ranges of the TPV, the process returns to S104.

In S110, the logical volume manager 213 swaps (exchanges) data of the RLU region assigned to the chunk n for data of the RLU region assigned to the new chunk together with the management information. That is, the logical volume manager 213 executes the process of replacing the chunks described with reference to FIG. 13.

In S111, the logical volume manager 213 updates the recommended path information 211D on the basis of details of the swap. The logical volume manager 213 counts the number of segments and updates the segment information 211E on the basis of the counted number of the segments.

In S112, the logical volume manager 213 determines whether or not the number of the segments is larger than the threshold for the number of recommended paths. For example, the logical volume manager 213 references the threshold information 211F to acquire the threshold for the number of recommended paths. The logical volume manager 213 compares the acquired threshold for the number of recommended paths with the number of the segments, which is represented by the segment information 211E after the update. If the number of the segments is larger than the threshold for the number of recommended paths, the process illustrated in FIGS. 14 and 15 is terminated. In this case, the process of executing a command, the process of responding about a status, and the like are executed, for example. On the other hand, if the number of the segments is not larger than the threshold for the number of recommended paths, the process proceeds to S113.

In S113, the logical volume manager 213 notifies the server 100 of SENSE requesting to rebuild multiple paths. When the process of S113 is terminated, the process illustrated in FIGS. 14 and 15 is terminated. In this case, the process of executing a command, the process of responding about a status, and the like are executed, for example. When multiple paths are rebuilt, the logical volume manager 213 provides, to the server 100, information of recommended paths on the basis of the recommended path information 211D after the update.

The flow of the process executed by the controller 201 is described above.

As described above, the controller 201 has the function of changing, upon an assignment of an RLU region to a new chunk, an arrangement of chunks assigned to a TPV so that the number of segments is smaller than a threshold for the number of recommended paths. The arrangement of the chunks assigned to the TPV is set by the function so as to ensure that the number of segments is not larger than the number which may be managed by the server 100. Thus, the number of recommended paths that are not managed by the server 100 is reduced. As a result, the number of times of access to RLU regions through access paths other than recommended paths is reduced, and thus a reduction in the access performance, which is caused by the execution of cross access, may be suppressed.

The second embodiment is described above.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage control device, comprising:
a plurality of controllers associated with a plurality of first storage regions assigned to one or more recording media, the controllers being configured to control access to first storage regions associated with the respective controllers; and
a plurality of storage units provided for the respective controllers, each of the storage units having a second storage region to which unit storage regions secured in the plurality of first storage regions are assigned, each of the unit storage regions being associated with any one of the controllers,
wherein
each of the controllers includes a processor configured to
assign a new unit storage region to the second storage region, and
change, upon the assignment of the new unit storage region, arrangement of the unit storage regions assigned to the second storage region so that unit storage regions associated with a same controller are continuously arranged in the second storage region.

2. The storage control device according to claim 1, wherein
the processor is further configured to
count a total number of groups of unit storage regions associated with a same controller and continuously arranged in the second storage region, and
determine whether the total number is larger than a predetermined threshold, and
the processor is configured to
perform the changing if it is determined that the total number is larger than the predetermined threshold.

3. The storage control device according to claim 1, wherein
the processor is configured to
assign the new unit storage region to the second storage region such that numbers of unit storage regions secured in the respective first storage regions are to be equal as far as possible.

4. A method for controlling a storage device, the method being executed by a first controller among a plurality of controllers included in a storage control device, the controllers being associated with a plurality of first storage regions assigned to one or more recording media included in the storage device, the storage control device including a plurality of storage units provided for the respective controllers, each of the storage units having a second storage region to which unit storage regions secured in the first storage regions are assigned, each of the unit storage regions being associated with any one of the controllers, the method comprising:
assigning, by the first controller, a new unit storage region to a provided storage region, the provided storage region being a second storage region of a storage unit provided for the first controller, and
changing, upon the assignment of the new unit storage region, arrangement of unit storage regions assigned to the provided storage region so that unit storage regions associated with a same controller are continuously arranged in the provided storage region.

5. The method according to claim 4, further comprising:
counting a total number of groups of unit storage regions associated with a same controller and continuously arranged in the provided storage region, and
determining whether the total number is larger than a predetermined threshold,
wherein
the first controller performs the changing if it is determined that the total number is larger than the predetermined threshold.

6. The method according to claim 4, wherein
the first controller assigns the new unit storage region to the provided storage region such that numbers of unit storage regions secured in the respective first storage regions are to be equal as far as possible.

7. A computer-readable recording medium having stored therein a program for causing a first computer among a plurality of computers included in a storage control device to execute a process, the computers being associated with a plurality of first storage regions, the storage control device including a plurality of storage units provided for the respective computers, each of the storage units having a second storage region to which unit storage regions secured in the first storage regions are assigned, each of the unit storage regions being associated with any one of the computers, the process comprising:
assigning a new unit storage region to a provided storage region, the provided storage region being a second storage region of a storage unit provided for the first computer, and
changing, upon the assignment of the new unit storage region, arrangement of unit storage regions assigned to the provided storage region so that unit storage regions associated with a same computer are continuously arranged in the provided storage region.
